(19) United States
(12) Patent Application Publication
(10) Pub. No.: US 2015/0339408 A1
(43) Pub. Date: Nov. 26, 2015

(54) UNIVERSAL TRANSACTION REPOSITORY

(71) Applicant: Bank of America Corporation, Charlotte, NC (US)

(72) Inventors: Sorin N. Cismas, Addison, TX (US); Manu Jacob Kurian, St. Louis, MO (US)

(73) Assignee: Bank of America Corporation, Charlotte, NC (US)

(21) Appl. No.: 14/286,041

(22) Filed: May 23, 2014

(51) Int. Cl. G06F 17/30

(52) U.S. Cl. CPC G06F 17/30997; G06F 17/30; G06F 17/30864

(57) ABSTRACT

Embodiments disclosed herein relate to systems, methods, and computer program products for providing an extensible input database and associated reference database. In some embodiments, the system and method provide an extensible input database and a graphical user interface for inputting data into the extensible input database; receive data from a user via the graphical user interface, the data comprising content for the extensible input database; generate a key for a reference database based on the content received from the user; populate the extensible input database with the content; and associate the content in the extensible input database with the key in the reference database. The extensible input database is flexible in receiving different types of data and reduces the number of databases needed in order to store different types of data.

### BACKGROUND

A wide variety of data is collected and stored by different institutions. For example, account data, customer data, transaction data, and the like, is collected and stored by financial institutions. In the past, a new database was created every time a new type of data was collected. New types of data may have different requirements in the numbers, formats, or types of data for a single data point. For example, transaction records may include data on the customer account, transaction amount, transaction date, merchant name, and the like. In contrast, social media data may include social media name, website address, and a binary indicator of a relationship between the customer and a webpage (e.g., has the customer “liked” the webpage). Both types of data can be stored but the data include different amounts of information, e.g., transaction data includes at least four fields and social media data includes only three fields, and the data is of a different format, e.g., account data includes numerical fields while social media data does. In this example, two different databases would be created to store the data for the transaction data and the social media data because different types and formats of data are present.

This need for separate databases results in a large number of inefficient databases. Records of what data are stored in which database need to be kept. It may be difficult to search across all records or aggregate data for searching across multiple databases.

Thus, there is a need for a system and method that can receive various types of data from different users without having to create a new instance of a database for each new type or set of data.

### BRIEF SUMMARY

The following presents a simplified summary of one or more embodiments of the disclosure in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments disclosed herein address the above needs and/or achieve other advantages by providing an apparatus (e.g., a system, computer program product, and/or other device) and a computer-implemented method for providing an extensible input database and associated reference database. In some embodiments, the system provides an extensible input database and a graphical user interface for inputting data into the extensible input database; receives data from a user via the graphical user interface, the data comprising content for the extensible input database; generates a key for a reference database based on the content received from the user; populates the extensible input database with the content; and associates the content in the extensible input database with the key in the reference database.

In some embodiments, the module further includes instruction code executable by one or more computing processors, and configured to cause the one or more computing processors to: generate an index for the extensible input database based at least in part on the reference database; and perform a search for content in the extensible input database using the index. In an embodiment, the data received from the user via the graphical user interface further includes metadata, and the key is generated using both the content and the metadata.

In some embodiments, the module further includes instruction code executable by one or more computing processors, and configured to cause the one or more computing processors to: track the content populated into the extensible input database; and tag the content based on an identifier associated with the user.

In an embodiment, populating the extensible input database with the content includes evaluating the key to determine the database structures associated with the content; and adding the database structures associated with the content to the extensible input database. In some embodiments, the key is selected from the group consisting of a key to the structure of the data, a key to the format of the data, and a key to the communication channels of the data. In still further embodiments, the memory includes a plurality of geographically separated servers.

Computer program products and computer-implemented methods may also be provided.

Other aspects and features, as recited by the claims, will become apparent to those skilled in the art upon review of the following non-limited detailed description of the disclosure in conjunction with the accompanying figures.

### BRIEF DESCRIPTION OF THE SEVERAL VIEWS OF THE DRAWINGS

Having thus described embodiments in general terms, reference will now be made to the accompanying drawings, which are not necessarily drawn to scale, and wherein:

FIG. 1 provides an extensible input database environment wherein an input database is associated with a reference database in order to reduce simplify data storage structures, in accordance with one embodiment of the present disclosure;

FIG. 2 provides an extensible input database search process in which the extensible input database is generated and searched in association with a reference database, in accordance with one embodiment of the present disclosure;

FIG. 3 provides illustrates a block diagram for an extensible input database environment and system, in accordance with one embodiment of the present disclosure; and

FIG. 4 provides an example of an extensible input database and an associated reference database, in accordance with an embodiment of the present disclosure.

### DETAILED DESCRIPTION

Embodiments will now be described more fully hereinafter with reference to the accompanying drawings, in which some, but not all, embodiments are shown. Indeed, the disclosure may be embodied in many different forms and should not be construed as limited to the embodiments set forth herein; rather, these embodiments are provided so that this disclosure may satisfy applicable legal requirements. Like numbers refer to like elements throughout.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” It should also be understood that while some embodiments describe the methods or products as comprising one or more elements, the methods or elements may also consist of or consist essentially of the elements disclosed herein.

It should be understood that terms like “bank,” “financial institution,” and “institution” are used herein in their broadest sense. Institutions, organizations, or even individuals that process financial transactions are widely varied in their organization and structure. Terms like “financial institution” are intended to encompass all such possibilities, including but not limited to banks, finance companies, stock brokerages, credit unions, savings and loans, mortgage companies, insurance companies, and/or the like. Additionally, disclosed embodiments may suggest or illustrate the use of agencies or contractors external to the financial institution to perform some of the calculations, data delivery services, and/or authentication services. These illustrations are examples only, and an institution or business can implement the entire method and system on their own computer systems or even a single work station if appropriate databases are present and can be accessed.

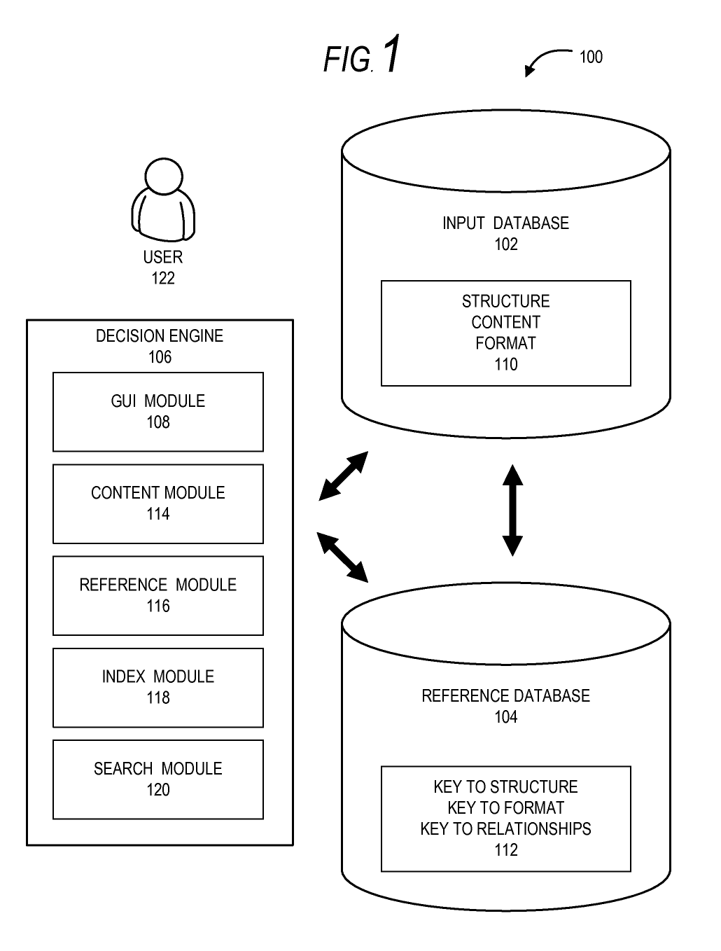

FIG. 1 illustrates an environment 100 in which an input database 102 is associated with a reference database 104 by a decision engine 106, e.g., a computing device processor programmed to carry out steps to update the input database as disclosed herein. In some embodiments, the decision engine 106 receives data from a user 122 via a graphical user interface (GUI) module 108. In an embodiment, the GUI module 108 presents a graphical user interface designed to received content of varying types to the user 122, and then receives the content when entered by the user 122.

In an embodiment, the decision engine 106 also includes a content module 114 that is configured to analyze the content in order to generate information for the reference database 104. The content module 114 may determine the type of content, the format of the content, the needed number of cells to appropriately store the content, metadata associated with the content, or the like.

In some embodiments, the decision engine 106 includes a reference module 116 that is configured to generate keys 112 in the reference database 104. The keys provide information on the type of content that is entered by the user for storage in the input database 102. For example, the keys 112 may include a key as to the structure of the data (e.g., four fields are necessary in the input database to store the data received from the user), a key to the format of the data (e.g., two of the four fields may be text fields and two of the fields may be number fields), and/or a key to the relationship of the data (e.g., the fourth field may be a current account balance field that is associated with a number external to the input database 102 such as a transaction register).

In further embodiments, the decision engine 106 includes an index module 118 that generates an index based on the reference database 104. The index is used to facilitate searching of the input database 102 by minimizing the fields that need to be searched.

In some embodiments, the decision engine 106 also includes a search module 120 that searches the input database 102 for content. In some embodiments, the search module 120 uses the reference database 104, including the keys 112, and/or uses the index to facilitate searching.

Additional embodiments will now be described in further detail in order to provide additional concepts and examples related to how extensible input databases and associated reference databases may be provided in accordance with additional embodiments of the disclosure. One skilled in the art would understand that while this specification provides an example of extensible input databases among financial institutions, these databases can be used in other settings as well. For example, databases for merchants may use the extensible input database to track information relating to stock on hand.

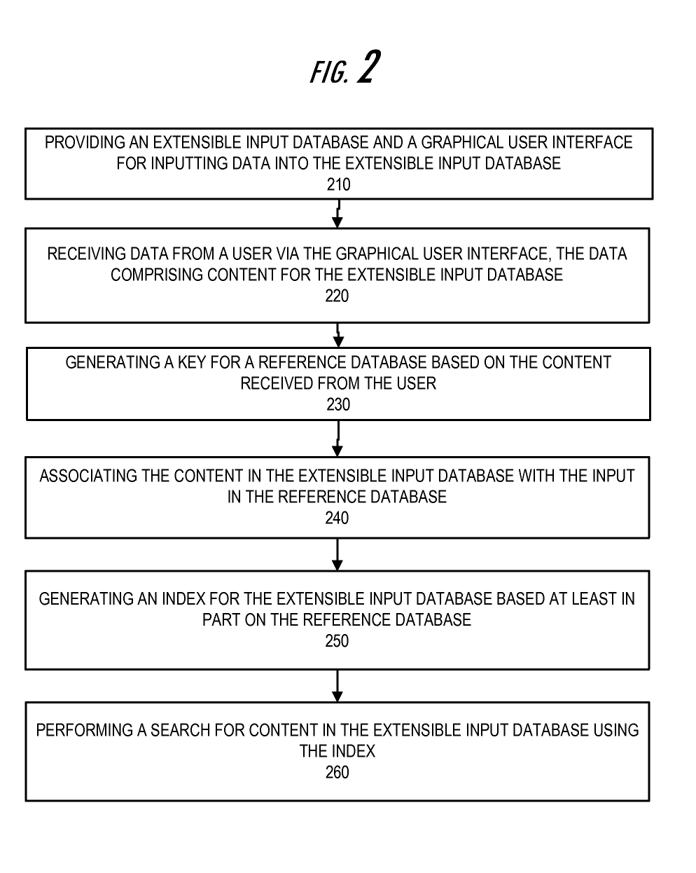

Turning now to FIG. 2, a system and method are disclosed for providing an extensible input database, wherein the extensible input database is configured to receive and store content of varying types, whereby the extensible input database is associated with a reference database comprising a key to the varying types. In an embodiment, the system and/or method provide an extensible input database and a graphical user interface for inputting data into the extensible input database; receive data from a user via the graphical user interface, the data comprising content for the extensible input database; generate a key for a reference database based on the content received from the user; populate the extensible input database with the content; and associate the content in the extensible input database with the input in the reference database.

In block 210, the system provides an extensible input database and a graphical user interface for inputting data into the extensible input database. In an embodiment, an extensible input database is a database that is capable of receiving varying types of data as content and accommodating different amounts of data, different types of data, different sources of data, and the like. In some embodiments, the extensible input database is a single data storage facility that includes varying types of content stored in the same memory structures. For example, an extensible input database may be configured as a single table. Each new input of content is placed in a row in the table. There may be a different number of columns for each new input of content. For example, a first person may enter data comprising a text input and three number inputs. A second person may then enter data comprising two number inputs and a date input. Previously, a single database structure would not be able to handle the different types and number of content and a new database was created for different types of input. The extensible input database, however, can receive and store different types in a compact, easily searchable, and efficient data structure. It should be understood that the example of a table is merely exemplary and other types of unified database structures are possible. For example, object-oriented databases may comprise fields and relationships between fields. The extensible input database may permit the expansion of object-oriented databases so that a new instance of the database is not necessary every time a new type of data content is desired to be input into a database.

In some embodiments, the system provides the extensible input database as an empty database ready to receive input. In further embodiments, the system provides the extensible input database to a user wherein the database already includes content. For example, a user may request access to a database for storage of a known or new type of data content, e.g., account numbers and social media identifiers associated with a social media contest or the like. Rather than creating a new database for the new type of data content, the system would provide the extensible input database to the user for input of the data.

In some embodiments, the system also provides a graphical user interface to the user for input of the data. For example, a script, webpage, or application screen in a computing device may be presented to a user for input of the data. The design of the graphical user interface may vary. For example, the design may be customized for the specific division of the institution providing the graphical user interface. In some embodiments, the design of the graphical user interface is configured to ensure that the content is received. For example, the design may include cells for receiving input. In an embodiment, a predetermined number of cells are provided while in other embodiments once data is input into a cell, a new empty cell is provided to the user. In this way, the number of cells is not predetermined but expands to include various data types. In some embodiments, the design includes an input section for receiving metadata relating to the content.

In an embodiment, the data is related to financial transactions or customers of financial institutions. Data may be characterized by content, e.g., a user's name, by type, e.g., textual data, by source, e.g., data received by customer input, by date, e.g., date received, or by a variety of other metrics for characterizing data. The data may be converted from an input type such as alphabetically input via a keyboard into a computer readable type such as binary data. In an embodiment, the data is individual input by a user. In other embodiments, however, the data is input via a batch process. For example, the data may be received by a program or the like and stored in a table, complementary database, text file, comma delimited file, or the like. The batch process transports the data from the source into the extensible input database.

In some embodiments, data types, such as textual data, numbers, dates, locations, percentages, and the like, are stored in conjunction with the content of the data. For example, a cell may have both content and format. The content is the data input into the cell. The format is the type of data in the cell. For example, a cell that is formatted as a number may be permitted to have mathematical functions performed on it while a cell that is formatted as a location may be GPS coordinates that could be mapped via a mapping application. The data type may be received from the user or batch process, or the data type may be determined by the system. For example, the system may evaluate the content and assign a default or most likely data type. Content that consists of numbers may be assigned the number data type as a default. Content that consists of letters may be assigned the textual data type as a default. These defaults may be changed by the user or institution offering the system.

As discussed, in some embodiments, metadata is included with the data for input into the extensible input database. For example, the name of the person inputting the data may be recorded and associated with the content. Similarly, the date of input, the date the data was collected, source of the data, or the like may be considered metadata that is associated with one or more of the data types in the extensible input database.

In an embodiment, the extensible input database and the graphical user interface are provided to the user via a computing device processor. For example, a workstation at a financial institution may be set up to provide access to the database via the graphical user interface. In some embodiments, the extensible input database and the graphical user interface are provided on a mobile device, such as a personal digital assistant or mobile phone. In further embodiments, touch screens or automated teller machines are configured to provide customers access to the extensible input database in order to receive data directly from customers.

In block 220, the system receives data from a user via the graphical user interface, the data comprising content for the extensible input database. In an embodiment, the user enters the data via an input device, such as a keyboard, voice input device, or touch screen. In some embodiments, the graphical user interface is associated with a batch process that receives files comprising a plurality of data that is to be input into the extensible input database. For example, the graphical user interface may include a line for input of a filename or location on a system that is to be input into the graphical user interface.

In an embodiment, the data is received at a single time. For example, the user may input data into a graphical user interface, either individually or via a batch process. In some embodiments, however, the graphical user interface permits a user to set up a communication channel from a data source, such as a webpage for receiving information from customers, and the extensible input database. The communication channel transmits information from the data source to the extensible input database on an ongoing process. For example, the communication channel may transmit information to the extensible input database as soon as the data source receives the data, on a regular schedule, or at a time determined by a system administrator or the like.

In an embodiment, the system is used by users, such as employees of institutions, database administrators, customers of institutions, or the like. The user may first input a username, password, or some other credential in order to gain access to the database. In an exemplary embodiment, the user is an employee or customer of a financial institution. Based on the flexibility of the extensible input database, the users do not need to have specialized knowledge in database administration in order to input, store, and make available content in databases. While previously new instances of databases were required each time a user wanted to input a new type of data, the extensible input database system permits users to input new data types and content into an easily accessible and efficient database.

As used herein, content is the substance of the data received from the user. For example, if the data relates to new accounts opened by customers of the bank, the content may include the account number, the customer name, the customer address, the date the account was opened, or the like. This content is stored in the database in fields that are available, in some embodiments, to be searched and/or recovered. A wide variety of content may be stored in a database. Transaction information, relationship information between a customer and a financial institution, balance information, transfer information, demographic information, customer activity, and social media information are just a few of the many types of content that may be stored in a database for use by the institution managing the database or for user by third parties interested in the data.

In block 230, the system generates a key for a reference database based on the content received from the user. In some embodiments, the system is able to handle the various types of data by generating a key for a reference database. As used herein, a reference database is a second database that does not store the content received from the user but instead stores information on the data type and metadata related to the content. For example, if the content is a customer's name, account number, and balance, the reference database may include indications that the content includes three types of data, that the first type of data is textual data, that the second type of data is whole number, and that the third type of data is a decimal number. In some embodiments, metadata is also stored with the information on the content. For example, an indicator associated with the user who input the data may be stored with the information.

In some embodiments, the reference database includes information on every type of data that is input into the extensible input database. In one embodiment, the reference database includes a key to the extensible input database. The reference database may include individual information on the content in the extensible input database. For example, the reference database may include a row for each row of content in a table-based extensible input database. In another embodiment, the reference database may include a row for each row of unique data types in a table-based extensible input database. For example, if rows 1 through 5 included identical content types but different content in each row, e.g., a customer name in column 1, an account number in column 2, and a balance in column 3, the reference database may include only a single set of information indicating that rows 1 through 5 include a textual content, a whole number content, and a decimal number content.

In some embodiments, information for the key is input by the user. In other embodiments, the system generates the key based on an analysis of the content. For example, the system may evaluate the content and determine a format for cells or fields in which the content will be stored. Content that is textual in character may be characterized as a text format. The key is then generated to for the data type based on the determined format.

In some embodiments, the system populates the extensible input database with the content. For example, upon receiving the data from the user, the system inputs the content into the extensible input database. In an embodiment, the system first generates the key for the reference database based on at least one of user input and analysis of the input data, and then populates cells or fields in the extensible input database that are created based on the key.

In an embodiment, the system evaluates the key to determine the database structures associated with the content. As used herein, database structure is the cells or fields that are configured to receive the content in the extensible input database. The database structures may have relationships between one another and between external sources of data or reporting outputs. In some embodiments, the database structures have a format that facilitates manipulation or searching of the content in extensible input database. In some embodiments, the system evaluates the key to identify the format, number, and/or relationships between the fields that are required to store the content in the extensible input database.

In some embodiments, the system adds the database structures associated with the content to the extensible input database. For example, the system may add rows to a table-based database, wherein the format of the cells in the row and the number of columns in the row are dependent upon the content of the data that is being input into the extensible input database. In an embodiment, the system also establishes communication channels between the database structures and external data sources or reporting channels.

In block 240, the system associates the content in the extensible input database with the input in the reference database. In an embodiment, the content in the extensible input database is associated with the information in the reference database using a reference identifier, such as a row number or location number. For example, the content in the extensible input database may include the data received from the user as well as a row number that corresponds to a row in the reference database where the key to the content is presented.

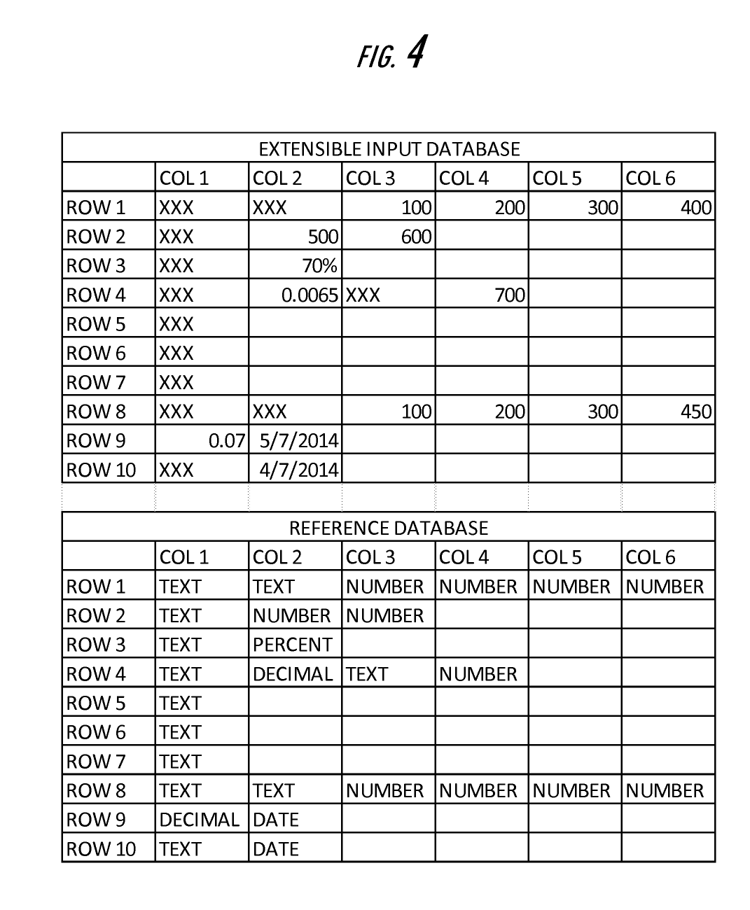

Turning briefly to FIG. 4, an example of an extensible input database and an associated reference database is provided. In FIG. 4, the extensible input database includes content (received from a user). The associated reference database includes information on the number and formatting of the cells in the extensible input database. When the reference database includes an empty cell, it indicates that no field is needed in the extensible input database. While the reference database includes a row corresponding to each row of the extensible input database, this is not necessary. As discussed, identically formatted rows in the extensible input database can be aggregated in the reference database to save space. In this example, rows 5, 6, and 7 of the extensible input database are formatted in the same way, i.e., a single text cell. The reference database in this example could include a single row that identifies the data type for rows 5, 6, and 7. In some embodiments, when the reference database includes aggregated data types the reference database also indicates which data in the extensible input database relates to the information in the reference database. For example, the reference database may indicate that rows 5, 6, and 7 are identically formatted.

Returning to FIG. 2, in block 250 the system generates an index for the extensible input database based at least in part on the reference database. In some embodiments, the index is an abbreviated form of the reference database that assists the system in searching the extensible input database for content. For example, the index may be a collection of format types and rows in the extensible input database in which the format type is present. When a search is performed for a specific type of formatted content, the system can exclude the rows for which the format type is not present.

In an embodiment, the system tracks the content populated into the extensible input database and tags the content based on an identifier associated with the user. In some embodiments, the system performs tracking of database changes such as tracking input received from users. In one embodiment, each user is provided a unique identifier and the identifier is included in the metadata associated with the content. This input permits the system to search not only based on content but also based on source of the data stored in the extensible input database.

In block 260, the system performs a search for content in the extensible input database using the index. In an embodiment, the search may be iterative over all of the content in the extensible input database. For example, the system may go row by row and field by field in the extensible input database searching for specific content. In some embodiments, the reference database and/or the index is used to search the extensible input database. For example, the system may exclude specific content in the extensible input database based on the reference database and/or index in order to speed up the search process.

The extensible input database and associated reference database, as disclosed herein, provides for a single content database that is flexible enough to store data of varying types and amounts. The extensible input database saves time and space, organizes data in a single database, and facilitates searching or filtering based on the reference database or an index generated therefrom. The extensible input database is simple to use and can be provided to a user along with a graphical user interface that allows the user to input data into the database. The user does not have to have specific knowledge regarding database structures or request a new database be created in order to store the data type. It should be understood that additional benefits of the extensible input database are available to providers and users of the system.

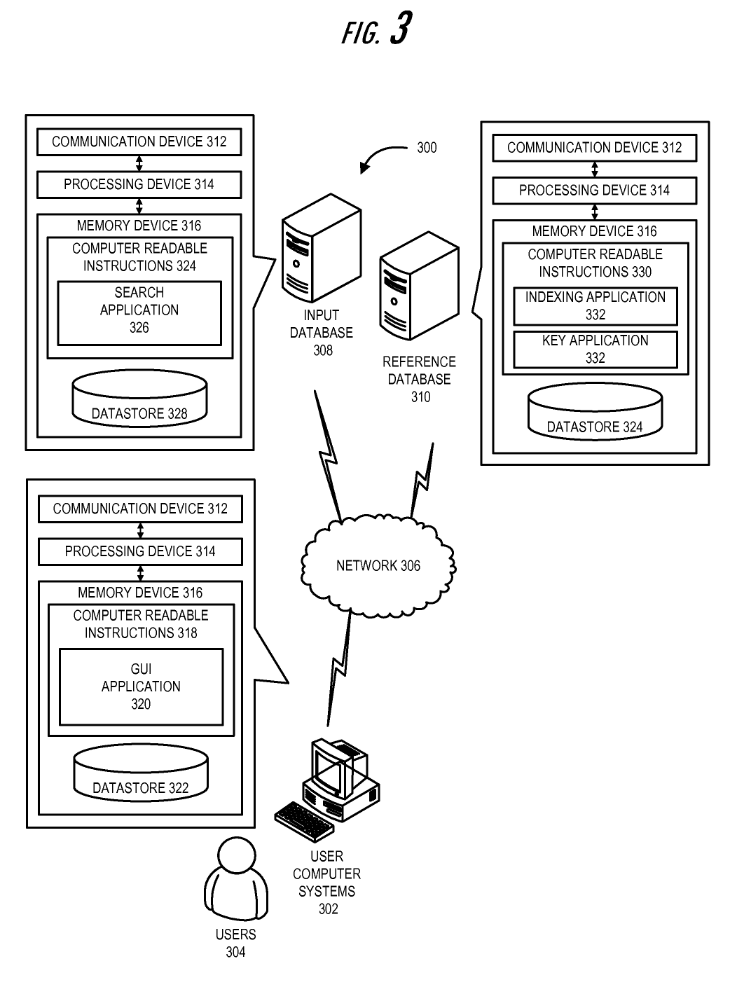

FIG. 3 illustrates a system 300 for providing an extensible input database, in accordance with an embodiment of the present disclosure. As illustrated in FIG. 3, the computer systems 302 of users 304 are operatively coupled, via a network 306, to the input database 308 and the reference database 310. In this way, the users 304 may utilize the user computer systems 302 to input content into the input database 308, implement the applications in the reference database 310, and update the input database 308 via the system. FIG. 3 illustrates only one example of embodiments of an extensible input database system 300, and it will be appreciated that in other embodiments one or more of the systems (e.g., computers, mobile devices, servers, or other like systems) may be combined into a single system or be made up of multiple systems.

The network 306 may be a global area network (GAN), such as the Internet, a wide area network (WAN), a local area network (LAN), or any other type of network or combination of networks. The network 306 may provide for wireline, wireless, or a combination of wireline and wireless communication between devices on the network.

As illustrated in FIG. 3, the user computer systems 302 generally comprise a communication device 312, a processing device 314, and a memory device 316. As used herein, the term “processing device” generally includes circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 314 is operatively coupled to the communication device 312 and the memory device 316. The processing device 314 uses the communication device 312 to communicate with the network 306 and other devices on the network 306, such as, but not limited to, the input database 308 and the reference database 310. As such, the communication device 312 generally comprises a modem, server, or other device for communicating with other devices on the network 306, and a display, camera, keypad, mouse, keyboard, microphone, and/or speakers for communicating with one or more users 304. The user computer systems 302 may include, for example, a personal device, which may be a personal computer, a laptop, a mobile device (e.g., phone, smartphone, tablet, or personal display device (“PDA”), or the like) or other like devices whether or not the devices are mentioned within this specification. In some embodiments, the user computer systems 302 could include a data capture device that is operatively coupled to the communication device 312, processing device 314, and the memory device 316. The data capture device could include devices such as, but not limited to a location determining device, such as a radio frequency identification (“RFID”) device, a global positioning satellite (“GPS”) device, Wi-Fi triangulation device, or the like, which can be used by a user 304, institution, or the like to capture information from a user 304, such as but not limited to the location of the user 304.

As further illustrated in FIG. 3, the user computer systems 302 comprises computer-readable instructions 318 stored in the memory device 316, which in one embodiment includes the computer-readable instructions 318 of a graphical user interface application 320 (e.g., an application that receives input from the user via the user computer system 302). In some embodiments, the memory device 316 includes a datastore 322 for storing data related to the user computer system 302, including but not limited to data input into and/or used by graphical user interface application 320.

As further illustrated in FIG. 3, the input database 308 generally includes a communication device 312, a processing device 314, and a memory device 316. The processing device 314 is operatively coupled to the communication device 312 and the memory device 316. The processing device 314 uses the communication device 312 to communicate with the network 306, and other devices on the network 306. As such, the communication device 312 generally comprises a modem, server, or other device(s) for communicating with other devices on the network 306.

As illustrated in FIG. 3, the input database 308 includes computer-readable program instructions 324 stored in the memory device 316, which in one embodiment includes the computer-readable instructions 324 of a search application 326. In some embodiments, the memory device 316 includes a datastore 328 for storing data related to the input database 308, including but not limited to data created and/or used by the search application 326. The search application 326 assists users in conducting searches for content in the input database 308.

As further illustrated in FIG. 3, the reference database 310 generally includes a communication device 312, a processing device 314, and a memory device 316. The processing device 314 is operatively coupled to the communication device 312 and the memory device 316.

As illustrated in FIG. 3, the reference database 310 includes computer-readable program instructions 330 stored in the memory device 316, which in one embodiment includes the computer-readable instructions 330 of an indexing application 332. In some embodiments, the memory device 316 includes a datastore 324 for storing data related to the implementation of the application, including but not limited to data created and/or used by the indexing application 322. The indexing application 322 generates an index of the reference key created via a key application 332.

It is understood that the servers, systems, and devices described herein illustrate one embodiment. It is further understood that one or more of the servers, systems, and devices can be combined in other embodiments and still function in the same or similar way as the embodiments described herein.

As will be appreciated by one of skill in the art, the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, resident software, micro-code, etc.), or an embodiment combining software and hardware aspects that may generally be referred to herein as a “system.” For example, various embodiments may take the form of web-implemented computer software. Furthermore, embodiments of the present disclosure may take the form of a computer program product on a computer-readable medium having computer-executable program code embodied in the medium.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present disclosure, however, the computer-readable medium may be transitory, such as, for example, a propagation signal including computer-executable program code portions embodied therein.

One or more computer-executable program code portions for carrying out operations of the present disclosure may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present disclosure are written in conventional procedural programming languages, such as the “C” programming languages and/or similar programming languages. The computer program code may alternatively or additionally be written in one or more multi-paradigm programming languages, such as, for example, F#.

Some embodiments of the present disclosure are described herein with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present disclosure.

As used herein, a processor/computer, which may include one or more processors/computers, may be “configured to” perform a stated function in a variety of ways, including, for example, by having one or more general-purpose circuits perform the stated function by executing one or more computer-executable program code portions embodied in a computer-readable medium, and/or by having one or more application-specific circuits perform the stated function.

While certain exemplary embodiments have been described and shown in the accompanying drawings, it is to be understood that such embodiments are merely illustrative of, and not restrictive on, the broad disclosure, and that this disclosure not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments may be configured without departing from the scope and spirit of the disclosure. Therefore, it is to be understood that, within the scope of the appended claims, the disclosure may be practiced other than as specifically described herein.

What is claimed is:

1. An apparatus for providing an extensible input database, wherein the extensible input database is configured to receive and store content of varying types, whereby the extensible input database is associated with a reference database comprising a key to the varying types, the apparatus comprising:
a memory;
a computing processor; and
a module stored in the memory, said module comprising instruction code executable by one or more computing processors, and configured to cause the one or more computing processors to:
provide an extensible input database and a graphical user interface for inputting data into the extensible input database;
receive data from a user via the graphical user interface, the data comprising content for the extensible input database;
generate a key for a reference database based on the content received from the user;
populate the extensible input database with the content; and
associate the content in the extensible input database with the key in the reference database.

2. The apparatus of claim 1, wherein the module further comprises instruction code executable by one or more computing processors, and configured to cause the one or more computing processors to:
generate an index for the extensible input database based at least in part on the reference database; and
perform a search for content in the extensible input database using the index.

3. The apparatus of claim 1, wherein the data received from the user via the graphical user interface further comprises metadata, and wherein the key is generated using both the content and the metadata.

4. The apparatus of claim 1, wherein the module further comprises instruction code executable by one or more computing processors, and configured to cause the one or more computing processors to:
track the content populated into the extensible input database; and
tag the content based on an identifier associated with the user.

5. The apparatus of claim 1, wherein populating the extensible input database with the content comprises:
evaluating the key to determine the database structures associated with the content; and
adding the database structures associated with the content to the extensible input database.

6. The apparatus of claim 5, wherein the key is selected from the group consisting of a key to the structure of the data, a key to the format of the data, and a key to the communication channels of the data.

7. The apparatus of claim 1, wherein the memory comprises a plurality of geographically separated servers.

8. A computer program product for providing an extensible input database, wherein the extensible input database is configured to receive and store content of varying types, whereby the extensible input database is associated with a reference database comprising a key to the varying types, the computer program product comprising:
a non-transitory computer-readable medium comprising:
an executable portion for causing a computer to provide an extensible input database and a graphical user interface for inputting data into the extensible input database;
an executable portion for causing a computer to receive data from a user via the graphical user interface, the data comprising content for the extensible input database;
an executable portion for causing a computer to generate a key for a reference database based on the content received from the user;
an executable portion for causing a computer to populate the extensible input database with the content; and
an executable portion for causing a computer to associate the content in the extensible input database with the key in the reference database.

9. The computer program product according to claim 8, wherein the non-transitory computer-readable medium further comprises:
an executable portion for causing a computer to generate an index for the extensible input database based at least in part on the reference database; and
an executable portion for causing a computer to perform a search for content in the extensible input database using the index.

10. The computer program product according to claim 8, wherein the data received from the user via the graphical user interface further comprises metadata, and wherein the key is generated using both the content and the metadata.

11. The computer program product according to claim 8, wherein the non-transitory computer-readable medium further comprises:
an executable portion for causing a computer to track the content populated into the extensible input database; and
an executable portion for causing a computer to tag the content based on an identifier associated with the user.

12. The computer program product according to claim 8, wherein populating the extensible input database with the content comprises:
evaluating the key to determine the database structures associated with the content; and
adding the database structures associated with the content to the extensible input database.

13. The computer-program product according to claim 12, wherein the key is selected from the group consisting of a key to the structure of the data, a key to the format of the data, and a key to the communication channels of the data.

14. The computer-program product according to claim 8, wherein the extensible input database is stored among a plurality of geographically separated servers.

15. A computer-implemented method for providing an extensible input database, wherein the extensible input database is configured to receive and store content of varying types, whereby the extensible input database is associated with a reference database comprising a key to the varying types, the method comprising:
providing, via a computing device processor, an extensible input database and a graphical user interface for inputting data into the extensible input database;
receiving, via a computing device processor, data from a user via the graphical user interface, the data comprising content for the extensible input database;
generating, via a computing device processor, a key for a reference database based on the content received from the user;
populating, via a computing device processor, the extensible input database with the content; and
associating, via a computing device processor, the content in the extensible input database with the key in the reference database.

16. The computer-implemented method of claim 15, the method further comprising:
generating an index for the extensible input database based at least in part on the reference database; and
performing a search for content in the extensible input database using the index.

17. The computer-implemented method of claim 15, wherein the data received from the user via the graphical user interface further comprises metadata, and wherein the key is generated using both the content and the metadata.

18. The computer-implemented method of claim 15, the method further comprising:
tracking the content populated into the extensible input database; and
tagging the content based on an identifier associated with the user.

19. The computer-implemented method of claim 15, the method further comprising:
evaluating the key to determine the database structures associated with the content; and
adding the database structures associated with the content to the extensible input database.

20. The computer-implemented method of claim 19, wherein the key is selected from the group consisting of a key to the structure of the data, a key to the format of the data, and a key to the communication channels of the data.
